(19) United States
(12) Patent Application Publication
(10) Pub. No.: US 2009/0205888 A1
(43) Pub. Date: Aug. 20, 2009

(54) METHOD FOR OPTIMISING THE CONSUMPTION OF A HYBRID VEHICLE

(76) Inventors: Frank Steuernagel, Stuttgart (DE); Bernd Dittmer, Ludwigsburg (DE)

Correspondence Address: MERCHANT & GOULD PC, P.O. BOX 2903, MINNEAPOLIS, MN, 55402-0903, US

(21) Appl. No.: 12/280,117

(22) PCT Filed: Jan. 30, 2007
(86) PCT No.: PCT/EP2007/050880

§ 371 Date: Oct. 8, 2008

(30) Foreign Application Priority Data
Feb. 21, 2006 (DE) 10 2006 007 983.3

(51) Int. Cl. B60W 10/06; B60W 20/00

(52) U.S. Cl. 180/65.265; 180/65.28; 180/65.25

(57) ABSTRACT

The invention relates to a method for optimizing the consumption of a hybrid drive, especially a hybrid drive for a motor vehicle comprising an internal combustion engine provided with a plurality of cylinders and at least one electric engine, the internal combustion engine and the electric engine being operated in parallel in the hybrid mode. According to the invention, at least one cylinder is disconnected in the partial load range of the internal combustion engine, a variation in the internal combustion engine power and/or the internal combustion engine power requirement being at least partially compensated by the electric engine.

### TECHNICAL FIELD

The method relates to a method for optimizing the consumption of a hybrid drive, especially a hybrid drive for a motor vehicle comprising an internal combustion engine provided with a plurality of cylinders and at least one electric engine, the internal combustion engine and the electric engine being operated in parallel in the hybrid mode.

### BACKGROUND

A method of this kind for optimizing the consumption of a hybrid drive is known. When much power is required as, for example, during acceleration of the motor vehicle, the internal combustion engine and the electric engine work together. In so doing, the internal combustion engine of the hybrid drive during the same maximum acceleration can be sized smaller in comparison to a conventional drive. The reduction in size of the internal combustion engine thereby partially compensates for the added weight of the hybrid drive. Because the internal combustion engine delivers a large torque in the upper rotational speed range, whereas the electric engine delivers a large torque in the lower rotational speed range, the electric engine complements the internal combustion engine in this method. An optimizing of the consumption therefore takes place, in that an operation of the internal combustion engine in operating ranges with low efficiency are avoided as much as possible. The combination of both engines in the hybrid drive can especially be of use during an idling phase or during the subsequent driveaway phase for the reduction of fuel consumption.

### SUMMARY

The method according to the invention for optimizing the consumption of a hybrid drive is thereby characterized, in that at least one cylinder is disconnected in the partial load range of the internal combustion engine, a variation in the internal combustion engine power and/or the internal combustion engine power requirement being at least partially compensated for by the electric engine. The internal combustion engine operating in the partial load range has a lower degree of efficiency than during an operation at an operating point slightly below the maximum torque. This is also true for each individual cylinder. By way of disconnecting the cylinder(s) (cylinder fade-out) in the partial load range, a smaller number of cylinders, which are not disconnected (active), generate a larger specific power so that the internal combustion engine achieves the same total power output. Because the individual cylinder works more effectively when the power requirement increases, the internal combustion engine also works overall more effectively. The overall degree of efficiency of the internal combustion engine is improved by the cylinder disconnection, and the internal combustion engine is operated in a more fuel-efficient manner. The driving dynamics of the motor vehicle are impaired when a cylinder is disconnected, for example short term power losses of the internal combustion engine. These impairments are at least partially compensated by the power output of the electric engine. Also when larger variations in the power requirement occur, as, for example, during a kickdown shift performed by the driver of the vehicle, the electric engine can at least partially compensate for the power absent in the internal combustion engine until all of the cylinders of the internal combustion engine are active again.

It is advantageous for a larger number of cylinders to be disconnected when the power requirement on the hybrid drive is smaller than when more power is required; and in so doing, the cylinders, which are not disconnected, work more efficiently. Depending on the power requirement and the percentage of the internal combustion engine power of the total power output of the hybrid drive, the number of the cylinders, which are not disconnected, is selected in such a way that these work in an operating range with a high degree of efficiency. This operating range and especially the operating point with the maximum degree of efficiency lie slightly below the range with the maximum torque.

Provision is made according to a modification of the invention for at least one operating parameter of the cylinders, which are not disconnected, to be selected in such a way that the internal combustion engine power—at the highest possible degree of efficiency of the internal combustion engine—is adapted to the power requirements. Because a tiered power spectrum results from disconnecting the cylinder(s) while utilizing a large specific power of the individual cylinders, certain operating parameters have to be adapted to the cylinders, which are not disconnected, for a more precise power gradation. This adaptation makes a continuous or at least an approximately continuous power variation of the internal combustion engine possible.

The operating parameters preferably determine the fuel supply and/or the supply of combustion air and/or the ignition timing. The operating parameters for influencing these variables are, for example, duration of injection of the fuel, throttle-valve angle in the intake manifold or advance angle adjustment of the ignition.

Especially with regard to internal combustion engines with an externally supplied ignition, the ignition timing can be selected independent of other operating parameters.

Furthermore, it is advantageous if the electric engine is controlled in an open loop and/or closed loop; in that when the internal combustion engine is running rough, the power fluctuations resulting from this are compensated by the electric engine. The power fluctuations resulting from the explosive combustion and the varying power output during different power cycles of the internal combustion engine are additionally increased by the disconnection of the cylinder. This increase occurs because the tuning of torque variations within a power cycle of the internal combustion engine is no longer guaranteed, and the internal combustion engine thus runs more unevenly. The electric motor can simultaneously compensate for the vibrations.

Provision is made according to a modification of the invention for different cylinders, especially cyclically, to be disconnected at different times in the partial load operating mode. In order to avoid a cooling down of the cylinders, which have been disconnected, and an irregular heat formation within the engine block, the work to be performed by the internal combustion engine can be distributed to different cylinders.

Provision is made according to a modification of the invention for kinetic energy of the motor vehicle during braking to be used by an electric generator to charge an electric storage unit assigned to the electric motor. Especially in city traffic, the recovery of energy (recuperation) significantly contributes to the reduction of fuel consumption. The conversion of kinetic energy of the motor vehicle into electrical energy can also be utilized in such cases, where a conventional drive is working during overrun conditions.

The compensation for the variation in the internal combustion engine power by the electric engine preferably takes place only at a charging state of the electrical storage unit, which is above a specified charging threshold. The charging state of the electrical storage unit is awarded the highest priority in this method. If the charging state lies above an upper threshold, the method is used so that the charging state is maintained in a range, wherein the electrical energy gained through recuperation can be effectively stored.

The electrical storage unit is preferably a rechargeable battery. The energy recovered through recuperation and converted into electrical energy can be simply stored in such a battery. Such a battery is easy and safe to handle and has an acceptable ratio between storage capacity and curb weight for a motor vehicle.

Moreover, it can be advantageous if the electric engine constitutes the electric generator. The electric engine can also selectively work as a generator and thus saves on a separate generator and an additional gearbox, which connects the wheels and the generator, as well as electrical lines, which connect the electrical storage unit to the generator.

Finally it is advantageous, if the cylinders are provided with valves, and thus the valves of the disconnected cylinders are set in such a way that the losses arising from gas conveyance and/or mechanical work are reduced.

### BRIEF DESCRIPTION OF THE DRAWINGS

The invention is subsequently explained in detail in an example of embodiment using the associated drawings. The following are shown:

FIG. 1 is a flow chart for a method for optimizing the consumption of a hybrid drive; and

FIG. 2 is a comparative description of the composition of the drive power in different operating situations.

### DETAILED DESCRIPTION

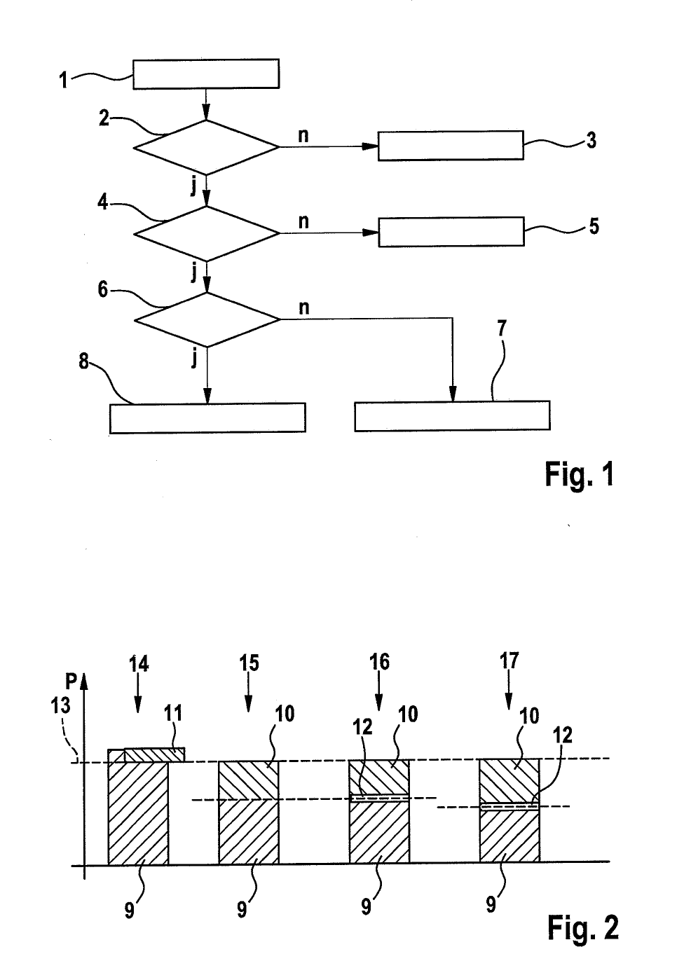

A flow chart for a method for optimizing the consumption of a hybrid drive is shown in FIG. 1, and in FIG. 2 the operating situations resulting from said method and the composition of their drive power are shown. The unspecified hybrid drive consists, for example, of an internal combustion engine provided with a plurality of cylinders, at least one electric engine, a gearbox which acts on the drive wheels and at least one electrical storage unit, which is assigned to the electric engine. In so doing, an output train of the internal combustion engine and an output train of the electric engine can in each case be engaged via a controllable clutch with an input train of the gearbox in such a way that the internal combustion engine and/or the electric engine actuate the drive wheels.

In the method shown in FIG. 1, the sequence of events is begun at a starting point 1, at which the hybrid drive can be situated in an arbitrary operating state, and branches out to a program point 2. A test is made at program point 2 to determine whether the charging state of the electrical storage unit is above a specified charging threshold. If this is not the case, the method branches out along the path denoted with the letter n (no) to program point 3, at which the method terminates. If at program point 2, the charging state is above the specified threshold, the method branches out along the path denoted with the letter j (yes) to the program point 4. A test is made at program point 4 to determine whether the internal combustion engine with its operating point is situated in the partial load range. If this is not the case, the method branches out along the path denoted with the letter n to program point 5, at which the method for optimizing the consumption of a hybrid drive terminates. Otherwise the method branches out along the path denoted with the letter j to program point 6. At program point 6, a query takes place to determine whether the specific fuel consumption of the internal combustion engine is minimal in relationship to the internal combustion engine power. If this is not the case, the method branches out along the path denoted with the letter n to program point 7, at which a certain number of cylinders are disconnected. This number results from a previously determined characteristic curve. The internal combustion engine power 9 remains approximately constant, slight variations of the internal combustion engine power 9 (for example power fluctuations due to uneven running) being compensated by the electric engine. If the specific fuel consumption is minimal during the query at program point 6, the method branches out along the path denoted with the letter j to program point 8. At program point 8, a disconnection of cylinders in connection with an adaptation of operating parameters, such as, for example, throttle valve position, duration of injection and/or advance angle adjustment of the ignition, to the power requirements takes place. At the same time, the electric engine compensates for larger variations in the internal combustion engine power. An additional operating parameter can, for example, also be an (optimal) gear ratio of an automatic transmission (for example: automatic transmission AT or continuous variable transmission CVT). After the method has passed through one of the program points 3, 5, 7, 8, it refers back to the starting point 1 (not shown in the flow chart).

The following operating situations result in accordance with the program points 3, 5, 7, 8: at program point 3, the charging state of the electrical storage unit is insufficient, so that the method for optimizing the consumption can not be applied. If, however, the charging state of the electrical storage unit lies above the specified charging threshold (program point 4), the electric drive is ready for an application of the method. The charging threshold is selected in such a way that the electrical storage unit is maintained at a charging state, at which the energy recovered through recuperation can be optimally stored in the electrical storage unit. At program point 5, the internal combustion engine is not operated in the partial load range, so that the method for optimizing the consumption can not be applied, because—for example during the full load operating mode—such a large power requirement on the internal combustion engine prevails that a cylinder disconnection is not possible. At program point 7, the internal combustion engine is situated in the partial load range, whereat a cylinder disconnection is implemented and only slight variations in the internal combustion engine power 9 arise, which at least partially can be compensated by the electric engine. At program point 8, the internal combustion engine is likewise situated in the partial load operating mode, whereat a cylinder disconnection is implemented. Additionally the operating parameters of the cylinders, which are not disconnected, are selected in such a way that an internal combustion engine consumption optimum can be achieved; however, in so doing, the internal combustion engine power 9 is reduced. The electric engine compensates for the power loss; and in so doing, a constant or approximately constant total power output 13 of the hybrid drive is achieved. In order to achieve this, the percentage of the power outputs from the internal combustion engine and the electric engine must previously be calculated with regard to a minimum specified fuel consumption using an optimization algorithm.

In FIG. 2, the percentages of the internal combustion engine power 9, electric engine drive power 10, electric generator power 11 and compensating power 12, which together comprise the total power output 13 for four operating situations of the hybrid drive, are indicated. In the first operating situation 14, which is characterized by a pure internal combustion engine drive, the total power output 13 is comprised of the internal combustion engine power 9 and the electric generator power 11, whereby the electric generator power 11 as a power requirement reduces the percentage of internal combustion engine power 9 of the total power output 13. This first operating situation 14 prevails, for example, if the charging state of the electrical storage unit has sunken below a critical charging threshold, at which an operation of the electric engine is impossible. The first operating situation 14 is also known from the conventional drive. The second operating situation 15 is characterized by a hybrid drive, whereby the internal combustion engine power 9 and the electric engine drive power 10 add up to the total power output 13. Such an operating situation 15 is, for example, present if none of the cylinders of the internal combustion engine are disconnected. The third operating situation 16 is characterized by a hybrid drive, in which at least one cylinder is disconnected and variations in the internal combustion engine power and/or variations in the internal combustion engine power requirement are compensated by the compensating power 12 of the electric engine. The compensating power 12 serves to compensate for the vibrations of the internal combustion engine. The internal combustion engine power 9 is constant. The total power output 13 of the hybrid drive comprises internal combustion engine power 9, compensating power 12, and electric engine drive power 10 in the third operating situation 16, wherein the reduced internal combustion engine power 9 vis-à-vis the second operating situation 15 is compensated by the additional compensating power 12 of the electric engine. This operating situation 16 prevails at program point 7 in the sequence of the method from FIG. 1. In the fourth operating situation 17, which is likewise characterized by the hybrid drive, cylinder disconnection and compensation, at least one operating parameter of the cylinders of the internal combustion engine, which are not disconnected, is adapted. This operating situation 17 prevails at program point 8 in the sequence of the method. A reduced internal combustion engine power 9 results, for example, vis-à-vis the third operating situation 16, which is compensated by a correspondingly larger electric engine drive power 10. In so doing, internal combustion engine power outputs 9, electric engine drive power 10 and compensating power 12 yield in sum the total power output 13. The compensating power 12 in the operating situation 17 is greater than in the operating situation 16 due to an increased vibration compensation.

1-12. (canceled)

13. A method of optimizing a consumption of a hybrid drive, especially a hybrid drive for a motor vehicle comprising an internal combustion engine provided with a plurality of cylinders and at least one electric engine, wherein the internal combustion engine and the at least one electric engine are operated in parallel in a hybrid mode, the method comprising:
disconnecting at least one of the plurality of cylinders in a partial load range of the internal combustion engine; wherein the at least one electric engine at least partially compensates for a variation in at least one of the internal combustion engine power or the internal combustion engine power requirement.

14. A method according to claim 13, further comprising disconnecting more of the plurality of cylinders during a smaller power requirement on the hybrid drive than during a larger power requirement; wherein the remaining of the plurality of cylinders that are not disconnected operate more efficiently.

15. A method according to claim 13, further comprising selecting at least one operating parameter of the plurality of cylinders that are not disconnected such that the efficiency of the internal combustion engine is maximized and the internal combustion power is adapted to the power requirements.

16. A method according to claim 15, wherein the at least one operating parameter determines one of:
a. a fuel supply;
b. a combustion air supply; or
c. an ignition timing.

17. A method according to claim 16, wherein the ignition timing is independent of other operating parameters for an internal combustion engine with an externally-supplied ignition.

18. A method according to claim 13, further comprising controlling the electric engine in an open loop or a closed loop such that when the internal combustion engine is running rough, power fluctuations resulting from the rough running are compensated by the electric engine.

19. A method according to claim 13, further comprising disconnecting respective cylinders of the plurality of cylinders at different times, especially cyclically, during a partial load operating mode.

20. A method according to claim 13, wherein kinetic energy of the motor vehicle when braking is utilized by an electric generator to charge an electrical storage unit assigned to the electric engine.

21. A method according to claim 13, wherein the at least partial compensation by the electric engine takes place only when a charging state of an electrical storage unit is above a specified charging threshold.

22. A method according to claim 20, wherein the electrical storage unit is a rechargeable battery.

23. A method according to claim 20, wherein the electric generator is an element of the electric engine.

24. A method according to claim 13, wherein each of the plurality of cylinders are provided with at least one valve, wherein the at least one valve of a disconnected cylinder is set such that a loss arising from a gas conveyance and/or mechanical work is reduced.
